(19) United States
(12) Patent Application Publication
(10) Pub. No.: US 2021/0339713 A1
(43) Pub. Date: Nov. 4, 2021

(54) System and Method of Heating an Undercarriage of a Vehicle

(71) Applicant: Derrick Demond Wallace, Rockingham, NC (US)

(72) Inventor: Derrick Demond Wallace, Rockingham, NC (US)

(21) Appl. No.: 17/244,843

(22) Filed: Apr. 29, 2021

Related U.S. Application Data
(60) Provisional application No. 63/017,417, filed on Apr. 29, 2020.

(51) Int. Cl. B60S 1/68; H05B 3/00; H05B 1/02; G07C 5/08

(52) U.S. Cl. CPC B60S 1/68; H05B 3/0042; B60K 35/00; G07C 5/0808; G07C 5/0816; H05B 1/0236

(57) ABSTRACT

A system is used to implement a method of heating an undercarriage of a vehicle. The system includes a vehicle with a controller, at least one heater, at least one positioning mechanism, and an undercarriage. The controller receives and processes each command and reading. The at least one heater applies heat for a desired area of a vehicle in order to melt snow and ice. The at least one positioning mechanism physically extends and retracts the heater. The undercarriage is the frame of vehicle that upholds and supports the rest of the vehicle. The method begins generating an activation command for the heater with the controller. The heater is moved from the retracted position to a deployed position in an accordance to the activation command with the positioning mechanism. A quantity of thermal energy is emitted in accordance to the activation command with the heater.

The current application claims a priority to the U.S. provisional patent application Ser. No. 63/017,417 filed on Apr. 29, 2020.

### FIELD OF THE INVENTION

The present invention generally relates to vehicle accessories. More specifically, the present invention is a system and method of heating an undercarriage of a vehicle.

### BACKGROUND OF THE INVENTION

The present invention provides an ice/snow melting system for vehicles. Currently, most vehicles are not properly equipped to drive in ice/snow conditions. Many vehicles have ice/snow driving modes which make it easier to drive in these conditions. However, these vehicles can still find it difficult to drive in ice/snow conditions. Other winter gear has been available which facilitate driving in the winter, such as winter chains that help increase traction on the wheels. However, in harsh conditions, these winter gear can be inefficient.

An objective of the present invention is to provide a safety system that during an ice or snowstorm will generate heat on the bottom of the vehicle to melt the ice and snow surrounding the vehicle while traveling. The present invention can be manually or automatically activated from the dashboard of the vehicle. Once activated, the system of the present invention turns on multiple heated lights which are lowered to begin melting the ice and/or snow. The heated lights emanate heat at a predetermined temperature range hot enough to melt ice and/or snow while the vehicle is travelling or stationary. The present invention also includes a switch to active heated lights, wiring to connect and power up the heated lights. Furthermore, the present invention can be integrated into the vehicle or retrofitted to the structure of the vehicle.

### BRIEF DESCRIPTION OF THE DRAWINGS

FIG. 1 is a schematic drawing illustrating at least one heater in a deployed position mounted underneath the undercarriage of a vehicle for the present invention.

FIG. 2 is a schematic drawing illustrating the at least one heater in the deployed position emitting a quantity of thermal energy for the present invention.

FIG. 3 is a schematic drawing illustrating at least one heater transitioning from a retracted position to the deployed for the present invention.

FIG. 4 is a diagram illustrating the system for the present invention.

FIG. 5 is a flowchart illustrating the overall process for the method of the present invention.

FIG. 6 is a flowchart illustrating the subprocess of determining if the ambient-condition data matches a winter-condition profile of a plurality of winter-condition profiles for the present invention.

FIG. 7 is a flowchart illustrating the subprocess of activating the at least one heater with a user interface of the vehicle for the present invention.

FIG. 8 is a flowchart illustrating the subprocess of moving the at least one heater outside of an internal compartment if the heater is in the deployed position for the present invention.

FIG. 9 is a continuation of the flowchart of FIG. 5 for the present invention.

FIG. 10 is a flowchart illustrating the subprocess of shutting off the at least one heater if the ambient-condition data matches a normal-condition profile of the plurality of winter-condition profiles for the present invention.

FIG. 11 is a flowchart illustrating the subprocess of shutting off the at least one heater with a deactivation command for the present invention.

FIG. 12 is a flowchart illustrating the subprocess of powering the at least one heater with a separate power source for the present invention.

FIG. 13 is a flowchart illustrating the subprocess of powering the at least one heater with an internal power source for the present invention.

FIG. 14 is a flowchart illustrating the subprocess of alerting a user with a warning notification with the controller for the present invention.

### DETAIL DESCRIPTIONS OF THE INVENTION

All illustrations of the drawings are for the purpose of describing selected versions of the present invention and are not intended to limit the scope of the present invention.

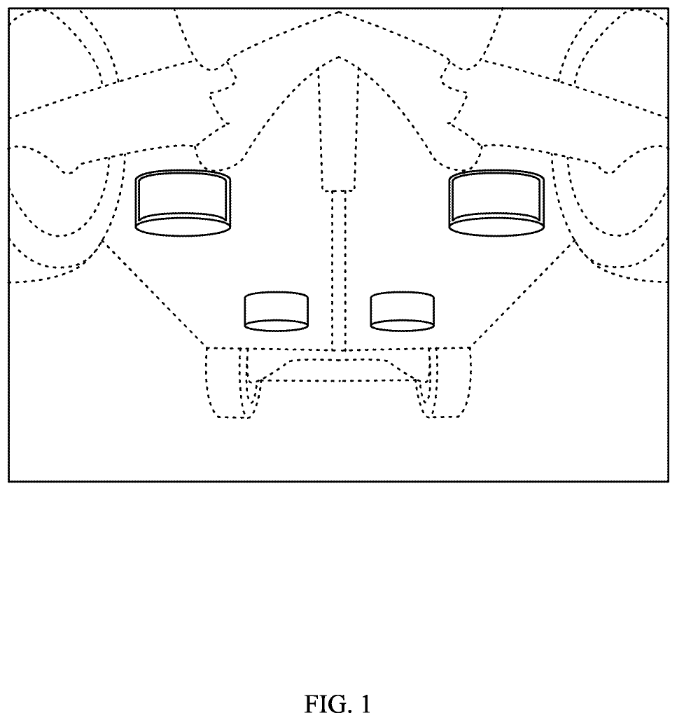

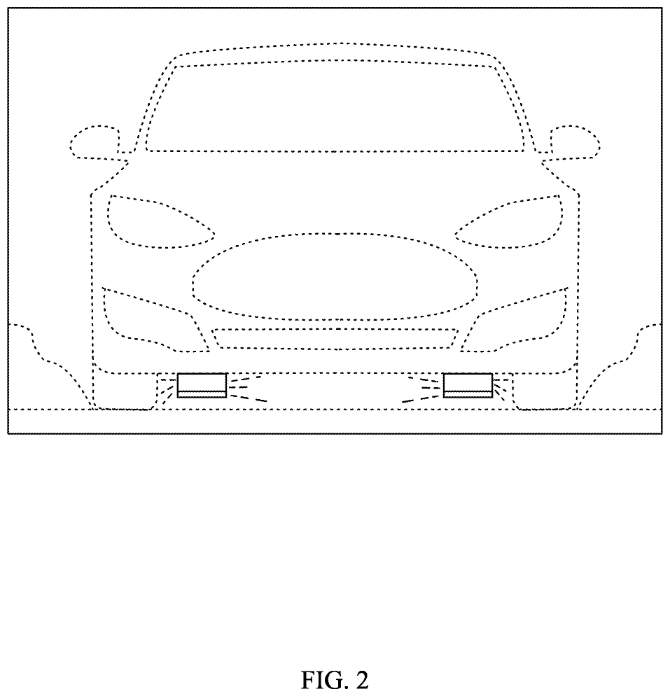

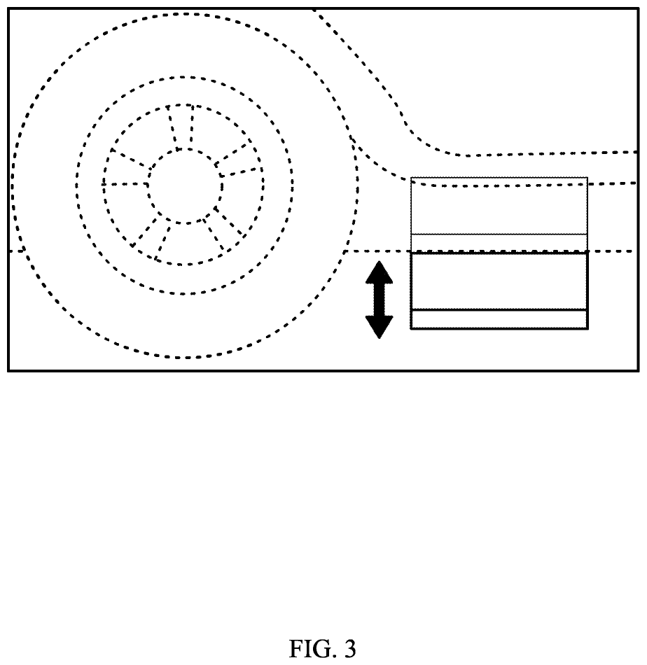

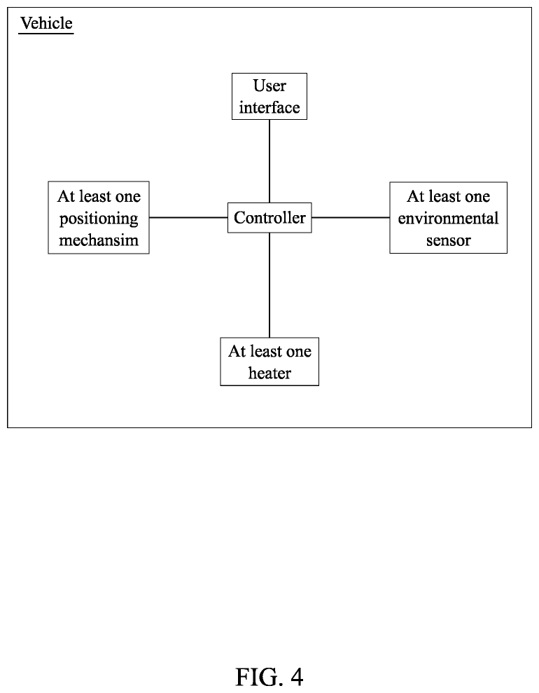

The present invention is a system and method of heating an undercarriage of a vehicle. The present invention eliminates or minimizes the amount of physical labor needed to physically remove snow and ice around a vehicle. More specifically, the present invention is able to target areas around a vehicle that are difficult to reach. The present invention may remove snow and ice around a vehicle before driving the vehicle and while driving the vehicle. The present invention reduces the amount of time needed to remove the snow and ice as well. Thus, the physical system used to implement the method for the present invention includes a vehicle, wherein the vehicle includes a controller, at least one heater, at least one positioning mechanism, and an undercarriage (Step A), seen in FIG. 1, FIG. 2, FIG. 3, and FIG. 4. The vehicle may be any vehicle such as a car, a truck, a sports utility vehicle, a sports car, and so on. The controller is used to manage the manual or automatic operation of the at least one heater and the at least one positioning mechanism. The at least one heater generates heat in a saft temperature range that is also warm enough to melt snow and ice. The at least one positioning mechanism physically extends and retracts the at least one heater towards a desired area of the vehicle and retracts the at least one heater to a safe area around the vehicle while not in use. The undercarriage is the frame beneath a vehicle that supports the rest of the vehicle. In order to protect the at least one heater while not in use, the heater is operatively integrated into the undercarriage by the positioning mechanism. In various embodiments of the present invention, the heater may be integrated into the chassis or vehicle body in order to target other desired areas around the vehicle. In the preferred embodiment of the present invention, the heater is a heating lamp. The heating lamp radiates enough heat to melt snow and ice without damaging the integrity of the vehicle. The positioning mechanism defaults the heater into a retracted position. The retracted position houses the heater within a housing while not in use. The controller is electronically connected to the heater and the positioning mechanism, which allows the controller to have two-way communication with the at least one heater and the positioning mechanism. Furthermore, the vehicle includes a plurality of wheels. Thus, in some embodiments, the at least one heater is a plurality of heaters, and each heater is adjacent to a corresponding wheel from the plurality of wheels as snow typically builds up from the ground up and surrounds each wheel. In alternate embodiments of the present invention, the vehicle includes a plurality of window frames and a roof. In these alternate embodiments of the present invention, the at least one heater is also a plurality of heaters and each heater is adjacent to a corresponding frame from the plurality of window frames and a roof.

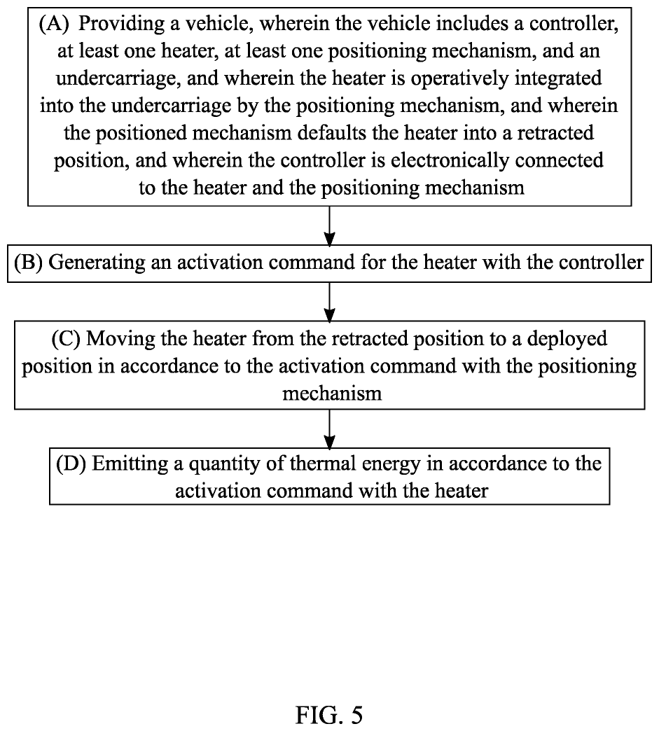

The overall process for the method of the present invention includes the following steps that are implemented with the vehicle, the controller, at least one heater, at least one positioning mechanism, and the undercarriage. The overall process begins by generating an activation command for the heater with the controller (Step B), seen in FIG. 5. In order for the heater to operate, the activation command engages the heater around the desired area of a vehicle. The heater is able to radiate heat across the desired area as the heater is then moved from the retracted position to a deployed position in accordance to the activation command with the positioning mechanism (Step C). The deployed position is the fully extended position of the heater that is necessary to target the desired area of the vehicle that is surrounded by snow and ice. A quantity of thermal energy is emitted in accordance to the activation command with the heater (Step D), thereby melting the snow and ice without any physical labor required. The quantity of thermal energy defines a safe temperature that effectively melts snow and ice within a given time period.

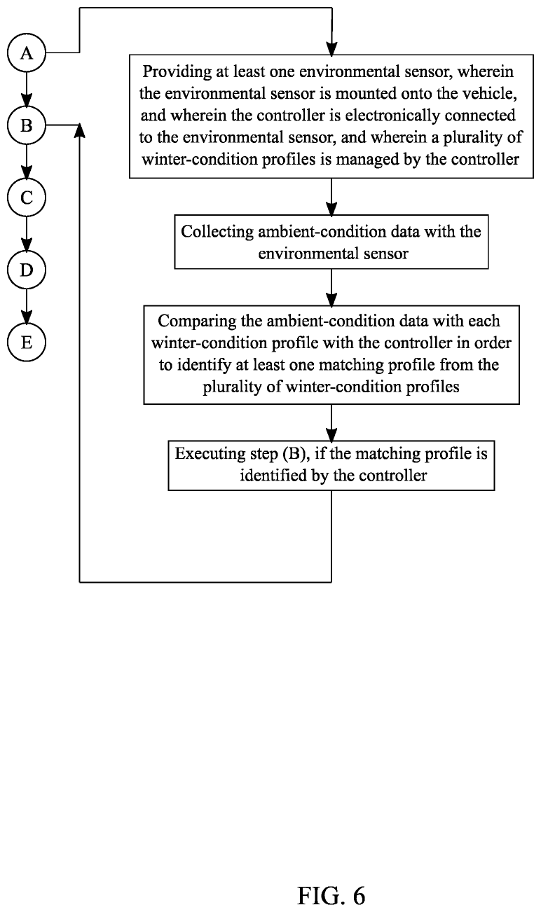

In order to determine how much heat and how long the heater needs to be operating, the system of the present invention further includes at least one environmental sensor, wherein the environmental sensor is mounted onto the vehicle, seen in FIG. 6. The at least one environmental sensor further enhances the safety of the present invention ensuring the presence of snow and ice before the activation command is applied. The controller is electronically connected to the environmental sensor so that the controller is able to process the readings of the environmental sensor. Furthermore, a plurality of winter-condition profiles is managed by the controller, thereby defining a set standard of conditions for the activation command. The plurality of winter-conditions may include, but is not limited to, snow accumulation, hail, ice accumulation, and so on. The current conditions of the surrounding environment are detected in order to apply the activation command as the ambient-condition data is collected with the environmental sensor. The current conditions are processed with the controller as the ambient-condition data is compared with each winter-condition profile with the controller in order to identify at least one matching profile from the plurality of winter-condition profiles. The heater is safely operated into the deployed position and the quantity of thermal energy is applied as Step B is executed, if the matching profile is identified by the controller.

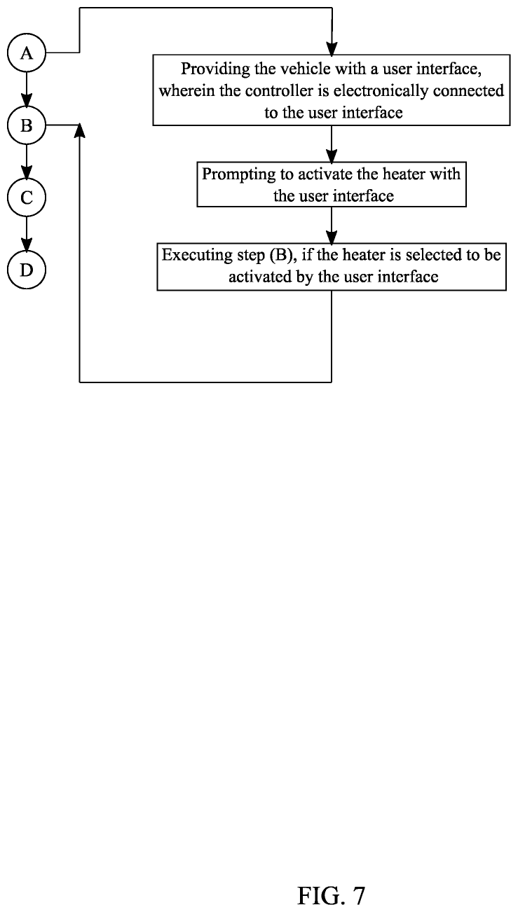

Furthermore, a user may directly manage the functions of the heater with the positioning mechanism, as well as define settings for automatic control as the vehicle includes a user interface, seen in FIG. 7. Moreover, the controller is electronically connected to the user interface, allowing the controller to have two-way communication with the user interface. The user interface manages the operations of the controller according to the inputs of the user. In order for a user to adjust or activate the controller, the user is prompted to activate the heater with the user interface. The input is processed as Step B is executed, only if the heater is selected to be activated by the user interface.

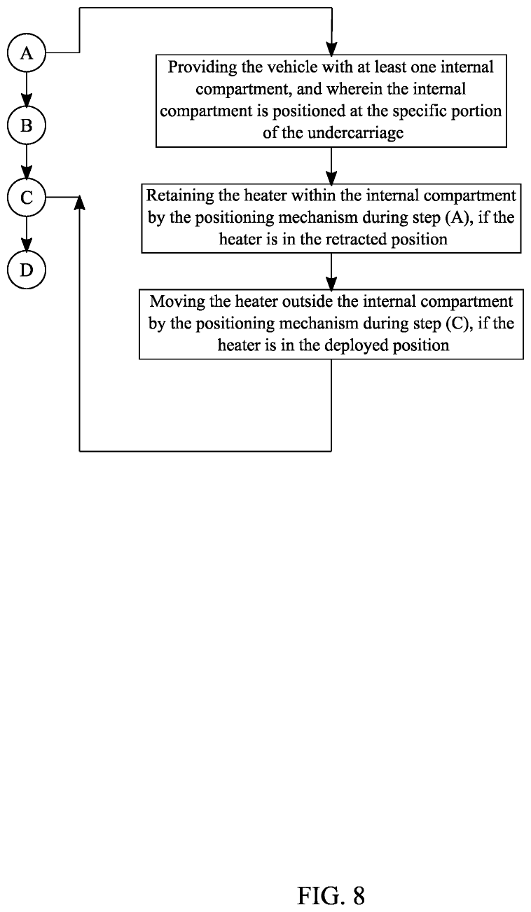

Furthermore, while in the retracted position, the heater is protected as the vehicle includes at least one internal compartment, wherein the internal compartment is positioned at the specific portion of the undercarriage, seen in FIG. 8. The internal compartment houses the heater and prevents the heater from being covered by snow or ice while not in use. In order to protect the heater while not in use, the heater is retained within the internal compartment by the positioning mechanism during Step A, if the heater is in the retracted position. The heater is moved outside the internal compartment by the positioning mechanism during Step C, if the heater is in the deployed position, thereby emitting the quantity of thermal energy directly to the desired areas such as the wheels.

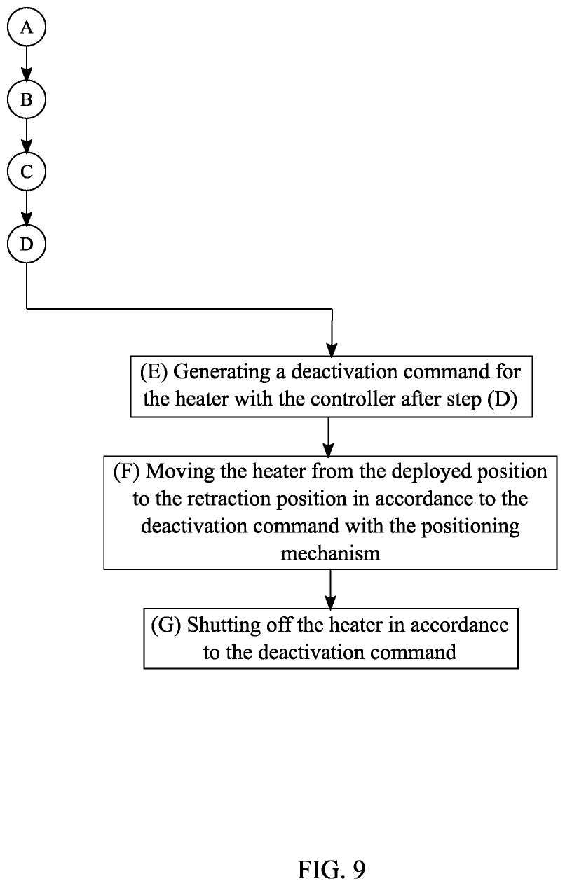

In order to further ensure the safety of the present invention, the overall process continues as a deactivation command is generated for the heater with the controller after Step D (Step E), seen in FIG. 9. The deactivation command halts the operations of the heater if the heater is not needed when there is not snow or ice. In order to completely remove the heater from the desired area of the vehicle, the heater is moved from the deployed position to the retraction position in accordance to the deactivation command with the positioning mechanism (Step F). The heater is then shut off in accordance to the deactivation command (Step G), thereby preventing the heater from damaging the internal compartment and the vehicle itself.

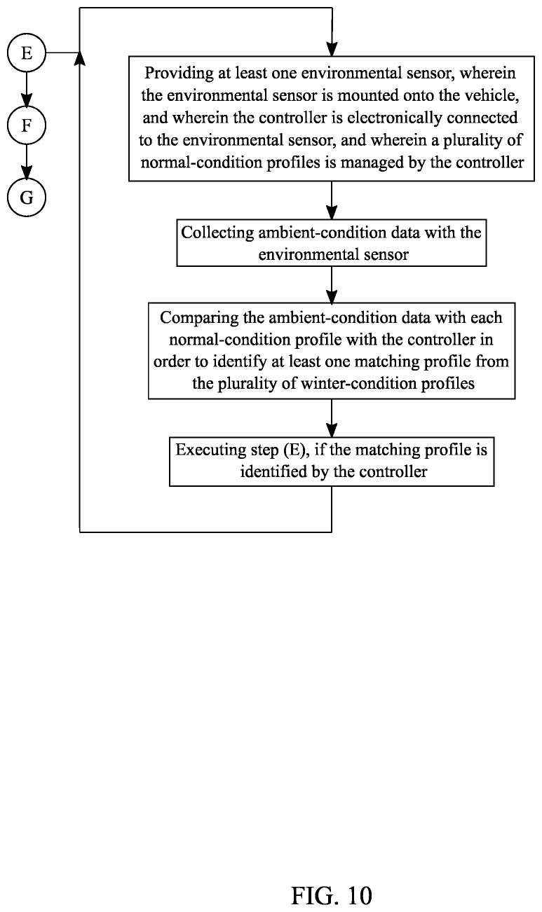

Once the heater has completely melted the snow and ice or the heater has been improperly activated to be in the deployed position, the system utilizes the at least one environmental sensor, wherein the environmental sensor is mounted onto the vehicle, seen in FIG. 10. The controller is electronically connected to the environmental sensor so that the controller is able to process the readings of the environmental sensor. A plurality of normal-condition profiles is managed by the controller, thereby defining a set standard for the deactivation command. The current conditions of the surrounding environment are detected in order to apply the deactivation command as the ambient-condition data is collected with the environmental sensor. The current conditions are processed with the controller as the ambient-condition data is then compared with each normal-condition profile with the controller in order to identify at least one matching profile from the plurality of winter-condition profiles. The heater stops operating as Step E is executed, if the matching profile is identified by the controller.

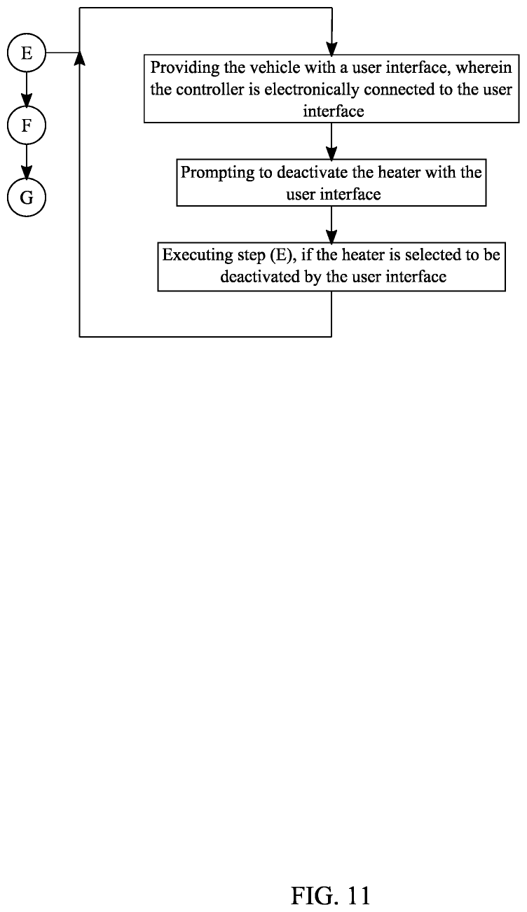

Furthermore, a user may also disengage the heater with the positioning mechanism, as well as adjust the settings for automatic control as the vehicle includes a user interface, wherein the controller is electronically connected to the user interface, seen in FIG. 11. In order for a user to adjust or deactivate the controller, the user is prompted to deactivate the heater with the user interface. The input is processed as Step E is executed, if the heater is selected to be deactivated by the user interface.

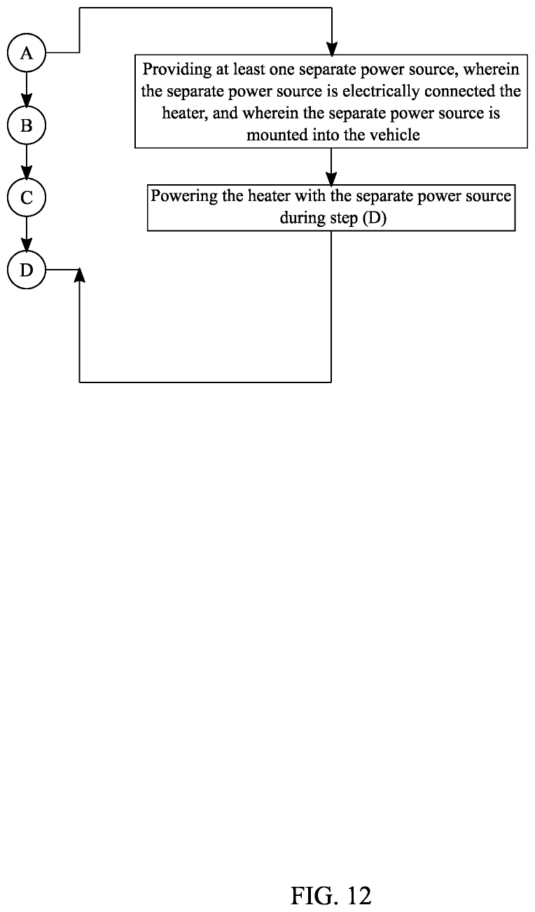

In order for the at least one heater to even generate the quantity of thermal energy, the system may further comprise at least one separate power source, wherein the separate power source is electrically connected to the heater and mounted into the vehicle, seen in FIG. 12. The at least one separate power source is preferably a portable power source such as a replaceable battery. In this embodiment, the at least one separate power source prevents the heater from draining the vehicle battery. The heater is powered with the separate power source during Step D, thereby supplying the heater only while in use and reserving the power source while not in use.

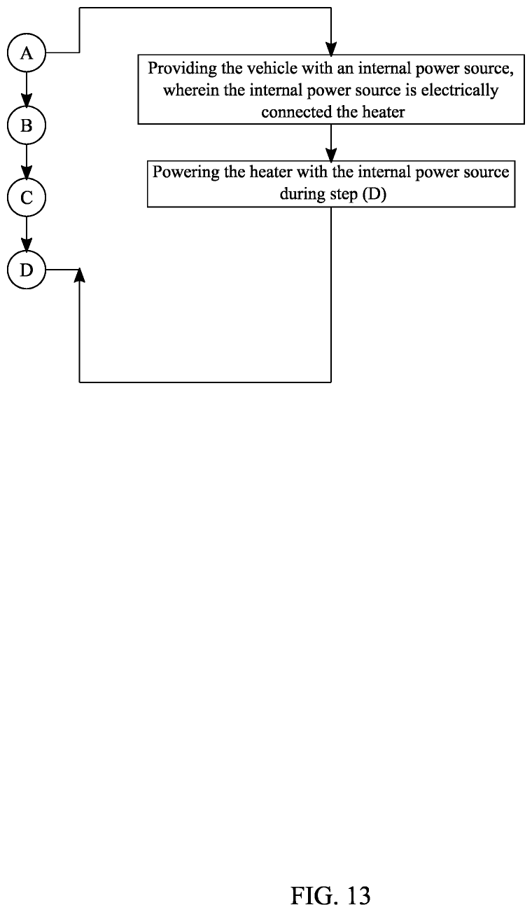

Alternatively, the vehicle may further include an internal power source, wherein the internal power source is electrically connected to the heater, seen in FIG. 13. The internal power source is the vehicle battery itself. The heater is therefore directly connected with the heater with a plurality of wires, and no additional unit is mounted into or onto the vehicle. Similarly, the heater is powered with the internal power source during Step D, thereby supplying the heater only while in use.

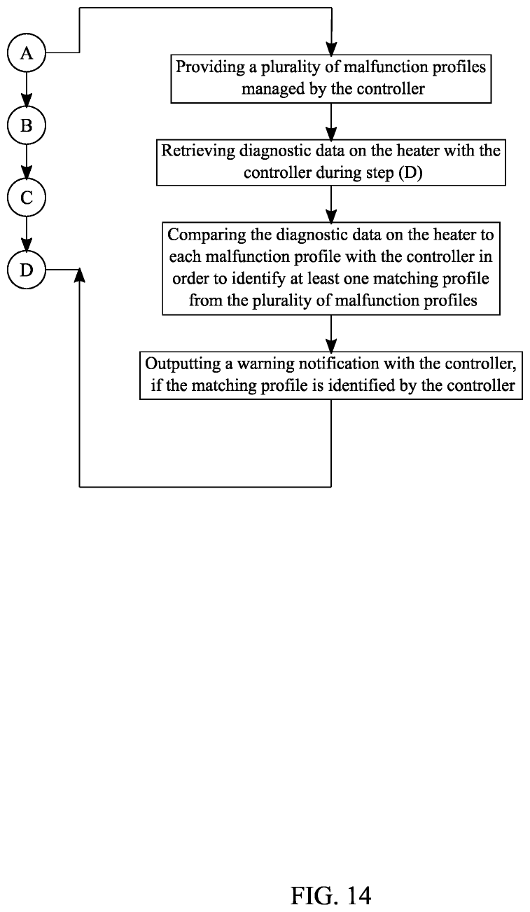

Similar with the at least one environmental sensor, the safety of the present invention is further preserved as the system further includes a plurality of malfunction profiles managed by the controller, seen in FIG. 14. The plurality of malfunction profiles defines a set standard of conditions that are unsafe with the mechanism of the heater. Current conditions of the heater are detected as diagnostic data on the heater is retrieved with the controller during Step D. The current conditions are processed with the controller as the diagnostic data on the heater is compared to each malfunction profile with the controller in order to identify at least one matching profile from the plurality of malfunction profiles. A warning notification is outputted with the controller, if the matching profile is identified by the controller, thereby alerting the user of a malfunction with the heater. The user then able to directly manage the heater, or the heater is automatically disabled with the controller.

Although the invention has been explained in relation to its preferred embodiment, it is to be understood that many other possible modifications and variations can be made without departing from the spirit and scope of the invention as hereinafter claimed.

What is claimed is:

1. A method of heating an undercarriage of a vehicle, the method comprising the steps of:
(A) providing a vehicle, wherein the vehicle includes a controller, at least one heater, at least one positioning mechanism, and an undercarriage, and wherein the heater is operatively integrated into the undercarriage by the positioning mechanism, and wherein the positioned mechanism defaults the heater into a retracted position, and wherein the controller is electronically connected to the heater and the positioning mechanism;
(B) generating an activation command for the heater with the controller;
(C) moving the heater from the retracted position to a deployed position in accordance to the activation command with the positioning mechanism;
(D) emitting a quantity of thermal energy in accordance to the activation command with the heater.

2. The method of heating an undercarriage of a vehicle, the method as claimed in claim 1, wherein the heater is a heating lamp.

3. The method of heating an undercarriage of a vehicle, the method as claimed in claim 1, wherein the vehicle includes a plurality of wheels, and wherein the at least one heater is a plurality of heaters, and wherein each heater is adjacent to a corresponding wheel from the plurality of wheels.

4. The method of heating an undercarriage of a vehicle, the method as claimed in claim 1 comprising the steps of:
providing at least one environmental sensor, wherein the environmental sensor is mounted onto the vehicle, and wherein the controller is electronically connected to the environmental sensor, and wherein a plurality of winter-condition profiles is managed by the controller;
collecting ambient-condition data with the environmental sensor;
comparing the ambient-condition data with each winter-condition profile with the controller in order to identify at least one matching profile from the plurality of winter-condition profiles; and,
executing step (B), if the matching profile is identified by the controller.

5. The method of heating an undercarriage of a vehicle, the method as claimed in claim 1 comprising the steps of:
providing the vehicle with a user interface, wherein the controller is electronically connected to the user interface;
prompting to activate the heater with the user interface; and,
executing step (B), if the heater is selected to be activated by the user interface.

6. The method of heating an undercarriage of a vehicle, the method as claimed in claim 1 comprising the steps of:
providing the vehicle with at least one internal compartment, and wherein the internal compartment is positioned at the specific portion of the undercarriage;
retaining the heater within the internal compartment by the positioning mechanism during step (A), if the heater is in the retracted position; and,
moving the heater outside the internal compartment by the positioning mechanism during step (C), if the heater is in the deployed position.

7. The method of heating an undercarriage of a vehicle, the method as claimed in claim 1 comprising the steps of:
(E) generating a deactivation command for the heater with the controller after step (D);
(F) moving the heater from the deployed position to the retraction position in accordance to the deactivation command with the positioning mechanism; and,
(G) shutting off the heater in accordance to the deactivation command.

8. The method of heating an undercarriage of a vehicle, the method as claimed in claim 7 comprising the steps of:
providing at least one environmental sensor, wherein the environmental sensor is mounted onto the vehicle, and wherein the controller is electronically connected to the environmental sensor, and wherein a plurality of normal-condition profiles is managed by the controller;
collecting ambient-condition data with the environmental sensor;
comparing the ambient-condition data with each normal-condition profile with the controller in order to identify at least one matching profile from the plurality of winter-condition profiles; and,
executing step (E), if the matching profile is identified by the controller.

9. The method of heating an undercarriage of a vehicle, the method as claimed in claim 7 comprising the steps of:
providing the vehicle with a user interface, wherein the controller is electronically connected to the user interface;
prompting to deactivate the heater with the user interface; and,
executing step (E), if the heater is selected to be deactivated by the user interface.

10. The method of heating an undercarriage of a vehicle, the method as claimed in claim 1 comprising the steps of:
providing at least one separate power source, wherein the separate power source is electrically connected the heater, and wherein the separate power source is mounted into the vehicle; and,
powering the heater with the separate power source during step (D).

11. The method of heating an undercarriage of a vehicle, the method as claimed in claim 1 comprising the steps of:
providing the vehicle with an internal power source, wherein the internal power source is electrically connected the heater; and,
powering the heater with the internal power source during step (D).

12. The method of heating an undercarriage of a vehicle, the method as claimed in claim 1 comprising the steps of:
providing a plurality of malfunction profiles managed by the controller;
retrieving diagnostic data on the heater with the controller during step (D);
comparing the diagnostic data on the heater to each malfunction profile with the controller in order to identify at least one matching profile from the plurality of malfunction profiles; and,
outputting a warning notification with the controller, if the matching profile is identified by the controller.
